(19) United States
(12) Patent Application Publication
(10) Pub. No.: US 2014/0081909 A1
(43) Pub. Date: Mar. 20, 2014

(54) LINKING SOCIAL MEDIA POSTS TO A CUSTOMERS ACCOUNT

(71) Applicant: salesforce.com, inc., San Francisco, CA (US)

(72) Inventors: Jeff Price, Halifax (CA); Shawn Crosby, Halifax (CA)

(73) Assignee: salesforce.com, inc., San Francisco, CA (US)

(21) Appl. No.: 14/025,339

(22) Filed: Sep. 12, 2013

Related U.S. Application Data
(60) Provisional application No. 61/701,258, filed on Sep. 14, 2012.
(60) Provisional application No. 61/701,267, filed on Sep. 14, 2012.

(51) Int. Cl. G06F 17/30

(52) U.S. Cl. CPC G06F 17/30345
USPC 707/609

(57) ABSTRACT

A system and method identifying an author of a social media post is provided. The system, for example, may include a customer database configured to store customer information, a communication system, and a processor communicatively connected to the customer database and the communication system. The processor may be configured to receive a social media post, update, when a tight matching parameter associated with the social media post matches customer information for a customer in the customer database, data associated with the customer based upon the social media post, and update, when a predetermined number of loose matching parameters associated with the social media post match customer information for the customer in the customer database, the data associated with the customer based upon the social media post.

### CROSS-REFERENCE TO RELATED APPLICATION(S)

This application claims the benefit of U.S. provisional patent application Ser. No. 61/701,258, filed Sep. 14, 2012, and U.S. provisional patent application Ser. No. 61/701,267, filed Sep. 14, 2012, the entire contents of which are incorporated by reference herein.

### TECHNICAL FIELD

The following relates to data processing systems and processes, and more particularly relates to systems and processes linking social media posts to a customer's account.

### BACKGROUND

Consumers use a wide variety of social media networks to stay in touch with friends, discuss current events, share photos and videos, and, more generally, create, share, and exchange information and ideas in virtual communities and networks. A single user may use a number of different social media networks. In some instances, a user may have a number of different accounts utilizing different aliases or usernames which may not correspond to the actual user's identity. Accordingly, identifying the actual owner of a social media account based upon a social media post can be difficult.

### DESCRIPTION OF THE DRAWING FIGURES

Exemplary embodiments will hereinafter be described in conjunction with the following drawing figures, wherein like numerals denote like elements, and

FIG. 1 is a block diagram of an exemplary multi-tenant data processing system, in accordance with an embodiment; and

FIG. 2 is a flow chart illustrating an exemplary method 200 of data extraction and matching, in accordance with an embodiment.

### DETAILED DESCRIPTION

According to various exemplary embodiments, systems and methods are provided to extract posts from one or more social media pipelines and the match the owners of the posts to customers in a database. A social media pipeline provides a dataset including the posts submitted to a social media network. If a post, for example, states “I just bought a Product X from Company Y, and it is awful,” a representative from Company Y may want to contact the owner of the post to offer assistance or discuss the users concerns with the product. However, the company may not have the user's social media username or alias associated with their record of the customer. Accordingly, as discussed in further detail below, a data extraction and matching system is provided to link social media posts with a customer record.

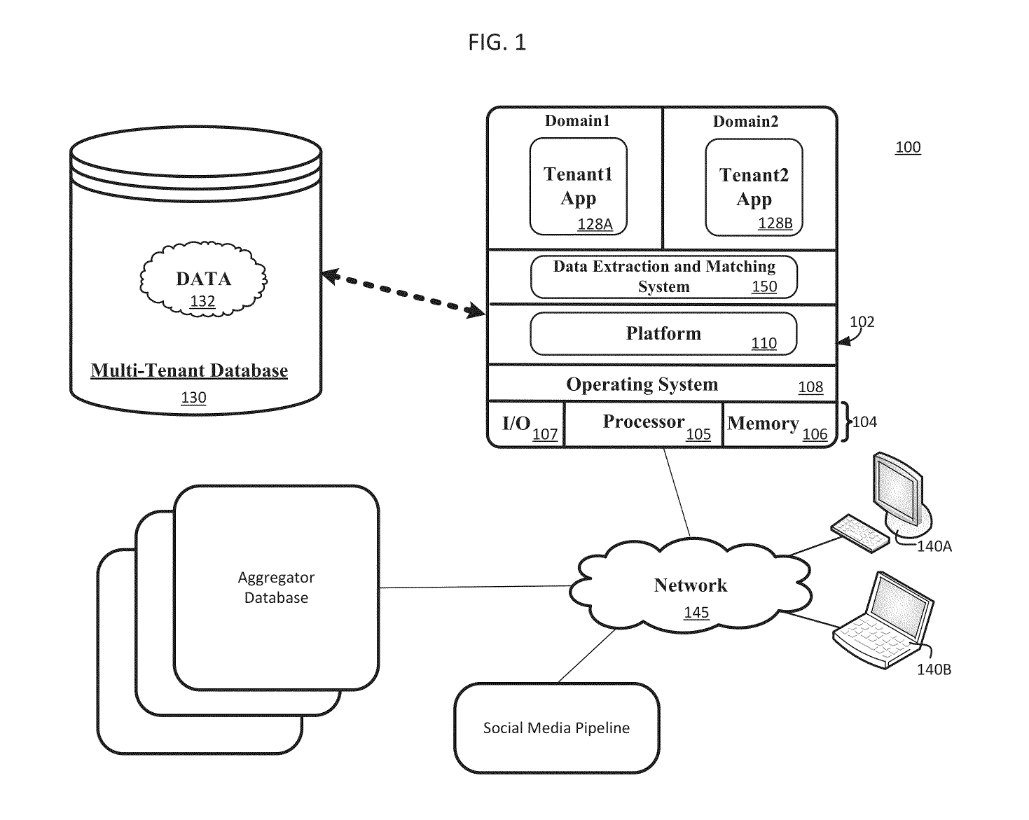

Turning now to FIG. 1, an exemplary multi-tenant application system 100 suitably includes a server 102 that dynamically creates virtual applications 128A-B based upon data 132 from a common database 130 that is shared between multiple tenants. Data and services generated by the virtual applications 128A-B are provided via network 145 to any number of client devices 140A-B, as desired. Each virtual application 128A-B is suitably generated at run-time using a common platform 110 that securely provides access to data 132 in database 130 for each of the various tenants subscribing to system 100. Each virtual application 128A-B may be accessible via a unique domain. For example, the virtual application 128A may be accessible on a first domain (e.g., http://www.companyname1.salesforce.com) and the application 128B may be accessible on a second domain (e.g., http://www.companyname2.com).

A “tenant” generally refers to a group of users that shares access to common data within database 130. Tenants may represent customers, customer departments, business or legal organizations, and/or any other entities that maintain data for particular sets of users within system 100. Although multiple tenants may share access to a common server 102 and database 130, the particular data and services provided from server 102 to each tenant can be securely isolated from those provided to other tenants. The multi-tenant architecture allows different sets of users to share functionality without necessarily sharing each other's data 132.

Database 130 is any sort of repository or other data storage system capable of storing and managing data 132 associated with any number of tenants. Database 130 may be implemented using any type of conventional database server hardware. In various embodiments, database 130 shares processing hardware 104 with server 102. In other embodiments, database 130 is implemented using separate physical and/or virtual database server hardware that communicates with server 102 to perform the various functions described herein.

Server 102 is implemented using one or more actual and/or virtual computing systems that collectively provide a dynamic application platform 110 for generating virtual applications 128A-B. Server 102 operates with any sort of conventional computing hardware 104, such as any processor 105, memory 106, input/output features 107 and the like. Processor 105 may be implemented using one or more of microprocessors, microcontrollers, processing cores and/or other computing resources spread across any number of distributed or integrated systems, including any number of “cloud-based” or other virtual systems. Memory 106 represents any non-transitory short or long term storage capable of storing programming instructions for execution on processor 105, including any sort of random access memory (RAM), read only memory (ROM), flash memory, magnetic or optical mass storage, and/or the like. Input/output features 107 represent conventional communication systems and interfaces to networks (e.g., to network 145, or any other local area, wide area or other network), mass storage, display devices, data entry devices and/or the like. In a typical embodiment, application platform 110 gains access to processing resources, communications interfaces and other features of hardware 104 using any sort of conventional or proprietary operating system 108. As noted above, server 102 may be implemented using a cluster of actual and/or virtual servers operating in conjunction with each other, typically in association with conventional network communications, cluster management, load balancing and other features as appropriate.

In one embodiment, for example, a tenant application 128A-B may be a customer relational management (CRM) application. A CRM application may be used to manage the client's current customers, previous customers and future prospective customers. The data on each customer could be gathered from sales records, warranty registrations, or in any other manner. Data corresponding to the tenant's customers may be stored, for example, in the database 130, which may also be referred to as a customer database. The database 130, however, may not store a customer's social media identification. Accordingly, as discussed above, if a customer were to post a message on a social media network related to the tenant, the tenant would have no ability to link the message with the customer's account in the database 130. Accordingly, the server 102 further includes a data extraction and matching system 150 to link social media posts with a customer record, as discussed in further detail below. The data extraction and matching system 150 may be formed from any combination of hardware and/or software. In one embodiment, for example, the data extraction and matching system 150 may include a non-transitory computer readable medium storing instructions, which when executed by a processor, cause the processor to link social media posts with customer records, as discussed in further detail below

The server 102 is connected to one or more social media pipelines 160. The social media pipeline(s) 160 provides a dataset including the social media posts submitted to a social media network. In one embodiment, for example, the social media network may be Twitter and the social media posts may be tweets. However, any social media network and respective post type could be gathered and transmitted to the server 102.

A tenant, via the data extraction and matching system 150, can search through the dataset provided from the social media pipeline 160. In one embodiment, for example, the tenant can set up a list of keywords. The keywords could correspond to search terms the tenant is interested in tracking In another embodiment, for example, an image or video could be set up to be tracked. The data extraction and matching system 150 may compare images, videos or elements included in media from social media posts to the tracked image or video to determine if the post is a duplicate of the tracked image or video, or if the post contains elements (such as a product of the tenant) of the tracked image or video. The keywords could also include hypertext transfer protocol addresses, social media unique identifiers (such as Twitter usernames, Facebook usernames, etc.), social media topics (e.g., a word or phrase prefixed with a # in the Twitter social media network). The tenant could also filter the dataset based upon a follower count.

The server is further connected to at least one data aggregator database 170. A data aggregator database 170 stores contact information for individuals. In one embodiment, for example, the data aggregator database may be provided by a service provider such as data.com. A data aggregator, such as data.com or Fliptop, keeps up to data information on businesses, including the names, email addresses phone numbers of the employees and owners of the business. In some instances, social media identifiers may be tracked and stored by the data aggregator, if available. As discussed in further detail below, the data extraction and matching system 150 can search the data aggregator databases 170 to determine if further information on the social media post author is available.

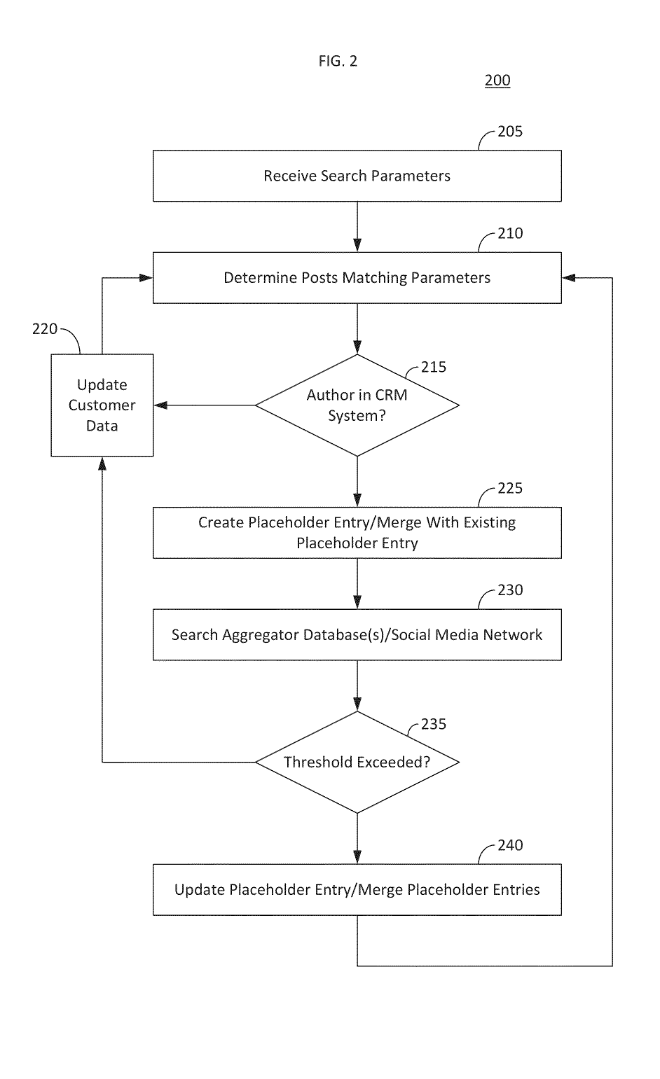

FIG. 2 is a flow chart illustrating an exemplary method 200 of data extraction and matching, in accordance with an embodiment. A user of the tenant first enters search parameters into a data extraction and matching system, such as the data extraction and matching system 150 illustrated in FIG. 1. (Step 205). The search parameters could include keywords corresponding to the tenant, such as the name of the company (full name, nicknames, etc.), the tenant's products, the tenant's competitors, or any other keywords related to the company's business and sales.

The system, then determines which posts from a social media network match the search parameters. (Step 210). In one embodiment, for example, a social media pipeline, such as the social media pipeline illustrated in FIG. 1, may include a database which the data extraction and matching system queries. In another embodiment, for example, a social media pipeline may transmit a feed of social media posts to the data extraction and matching system. In this embodiment, for example, the social media posts may be stored in a database, such as the database 130 illustrated in FIG. 1, for later analysis, analyzed in real time upon receipt, or a combination thereof.

The social media pipeline generally provides a username associated with the post. Accordingly, the data extraction and matching system first searches through customer records to see if the username is associated with a customer in the CRM system. (Step 215). If the author of the social media post is already linked to a customer's account, the data extraction and matching system updates the customer's account to include the new post and may flag the account for follow-up by a sales associate or other customer service representative. (Step 220).

If the username is not associated with a customer, the data extraction and matching system creates a placeholder entry in the database. (Step 225). The placeholder entry includes the username of the author and the content of the post. If a placeholder entry already exists which is associated with the social media username but not associated with a customer in the CRM system, the data extraction and matching system may merge the entries before attempting to further identify the social media post author.

The data extraction and matching system then performs a search to determine if any other linking information is available to identify the social media post author. (Step 230). In some embodiments, for example, the data extraction and matching system may be able to query the social media network where the post originated for information corresponding to the owner of the account, such as a name or email address, demographics, or any other identifying information that is publically available on the social media network. The data extraction and matching system may also search for information corresponding to the owner of the account in a data aggregator, such as the data aggregator 170 illustrated in FIG. 1. As discussed above, a data aggregator, such as data.com, keeps up to data information on businesses and their employees.

The data extraction and matching system then analyzes the data gathered by the search in step 230 and determines if a match threshold is exceeded. (Step 235). In one embodiment, for example, a match threshold could be set by the tenant. In some instances, for example, a tenant may want a tight matching system, where the username of the social media poster would have to be verifiably associated with the customer in the CRM database. In one embodiment, for example, a username of the social media poster may be verifiably associated with the customer in the CRM database if the data from the data aggregator or the social media website includes a unique identifier which matches a unique identifier associated with the customer in the CRM database. Unique identifiers may include, but are not limited to, an email address, a phone number, or any other unique identifier.

In other instances, a tenant may be satisfied with a loose matching threshold. Loose matching parameters are data points which are non-dispositive. In other words, data points which may identify a user, but which are not necessarily unique to the user, such as a name and demographic information. Other factors in the loose matching threshold may include, but are not limited to, an age or age range, a zip code, an area code, a geographic location associated with an internet protocol address, or other regional identifiers, a date of birth, a gender, a social media handle, a language and the content of the social media post. If, for example, the social media post recites “I just bought a Product X from Company Y,” the data extraction and matching system use the phrase “I just bought” to rule out potential matches if there is no record of the customer purchasing the “Product X” within a certain time period. In one embodiment, for example, a loose matching threshold may require three of the factors to match data for a customer in the CRM database in order to confidently verify the match. However, the loose matching threshold may also be independently set by a tenant, and, thus, the loose matching threshold could be set at any number of matching factors.

If the threshold set by the tenant (i.e., a tight matching threshold and/or a loose matching threshold) is exceeded, the data extraction and matching system updates the customer's account to include the social media username and new post and may flag the account for follow-up by a sales associate or other customer service representative. (Step 220). If the threshold set by the tenant (i.e., a tight matching threshold and/or a loose matching threshold) is not exceeded, the data extraction and matching system updates the placeholder entry to include any of the matching factors of the loose matching threshold which could be used to later verify the identity of the social media poster. (Step 240). In one embodiment, for example, the data extraction and matching system may attempt to merge placeholder entries if a predetermined number of loose matching threshold factors match between multiple placeholder entries. This may occur when a user has multiple different accounts on a single social media network, or a variant of accounts on a number of different social media networks. In one embodiment, for example, the merging threshold may be higher than the loose matching threshold; however, the merging threshold like the loose matching threshold can be individually set by the tenant. Accordingly, by merging accounts likely owned by the same user, the number of duplicate placeholder accounts in the system is reduced and the likelihood of matching the placeholder entry with a customer entry in the CRM database is increased.

While the system described herein could be used to link a social media user with customer records, one of ordinary skill in the art would recognize that the system may be used to identify the owner of a social media account in a variety of different settings.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A system identifying an author of a social media post, comprising:
a customer database configured to store customer information;
a communication system; and
a processor communicatively connected to the customer database and the communication system, the processor configured to:
receive the social media post;
update, when a tight matching parameter associated with the social media post matches customer information for a customer in the customer database, data associated with the customer based upon the social media post; and
update, when a predetermined number of loose matching parameters associated with the social media post match customer information for the customer in the customer database, the data associated with the customer based upon the social media post.

2. The system of claim 1, wherein the processor is further configured to:
receive one or more search parameters; and
determine social media posts which match the one or more search parameters.

3. The system of claim 2, wherein the processor is further configured to receive the social media post from a social media pipeline.

4. The system of claim 1, wherein the tight matching parameter is a social media username.

5. The system of claim 1, wherein the tight matching parameter is an email address.

6. The system of claim 1, wherein the tight matching parameter is a phone number.

7. The system of claim 1, where the processor is further configured to search, via the communication system, a social media network for loose matching parameters associated with the author of the social media post.

8. The system of claim 1, where the processor is further configured to search, via the communication system, a data aggregator for loose matching parameters associated with the author of the social media post.

9. The system of claim 8, wherein the loose matching parameters include a name and non-dispositive demographic data.

10. The system of claim 1, wherein the processor is further configured to create, when the author of the social media post is not in the customer database, a placeholder entry in the customer database.

11. The system of claim 10, wherein the processor is further configured to merge placeholder entries when a second predetermined number of loose matching parameters of respective placeholder entries match.

12. A method for identifying an author of a social media post, comprising:
receiving, by a processor, the social media post;
updating, by the processor, when a tight matching parameter associated with the social media post matches customer information for a customer in a customer database, data associated with the customer based upon the social media post; and
updating, by the processor, when a predetermined number of loose matching parameters associated with the social media post match customer information for the customer in the customer database, the data associated with the customer based upon the social media post.

13. The method of claim 12, further comprising:
receiving, by the processor, one or more search parameters; and
determining, by the processor, social media posts which match the one or more search parameters.

14. The method of claim 12, further comprising searching, by the processor via a communication interface, a social media network for loose matching parameters associated with the author of the social media post.

15. The method of claim 12, further comprising searching, by the processor via a communication interface, a data aggregator for loose matching parameters associated with the author of the social media post.

16. The method of claim 12, further comprising creating, when the author of the social media post is not in the customer database, a placeholder entry in the customer database.

17. The method of claim 12, further comprising merging placeholder entries when a second predetermined number of loose matching parameters of respective placeholder entries match.

18. A computer-readable medium storing instructions, which when executed by a processor cause the processor to:
receive one or more search parameters;
determine social media posts which match the one or more search parameters.
update, when a tight matching parameter associated with a respective social media post matches customer information for a customer in a customer database, data associated with the customer based upon the respective social media post; and
update, when a predetermined number of loose matching parameters associated with the respective social media post match customer information for the customer in the customer database, the data associated with the customer based upon the respective social media post.

19. The computer-readable medium of claim 18, wherein the instructions, when executed by the processor, further cause the processor to search, via a communication interface, a social media network for loose matching parameters associated with an author of the social media post.

20. The computer-readable medium of claim 18, wherein the instructions, when executed by the processor, further cause the processor to search, via a communication interface, a data aggregator for loose matching parameters associated with an author of the social media post.
